(19) United States
(12) Patent Application Publication
(10) Pub. No.: US 2018/0343068 A1
(43) Pub. Date: Nov. 29, 2018

(54) POWER LINE COMMUNICATION (PLC) INTERFERENCE MITIGATION FOR DIGITAL SUBSCRIBER LINE (DSL) NETWORKS

(71) Applicant: QUALCOMM Incorporated, San Diego, CA (US)

(72) Inventor: Hassan Afkhami, San Jose, CA (US)

(21) Appl. No.: 15/603,365

(22) Filed: May 23, 2017

(51) Int. Cl. H04B 15/00; H04B 3/54; H04B 3/50; H04B 17/345

(52) U.S. Cl. CPC H04B 15/00; H04B 17/345; H04B 3/50; H04B 3/542

(57) ABSTRACT

This disclosure provides methods, systems, and apparatuses supporting power line communication (PLC) interference mitigation for digital subscriber line (DSL) networks. A DSL device of a DSL network may detect interference on a set of DSL lines caused by multiple PLC devices of a PLC network. The DSL device may measure the aggregate interference from the multiple PLC devices without interrupting communication of the PLC devices. The measured aggregate network interference may be used to determine a mitigation parameter to be applied to each PLC device of the PLC network and the determined mitigation parameter may be adjusted based on subsequent measurements of aggregate network interference or of interference caused by an individual PLC device.

### TECHNICAL FIELD

The following relates generally to wireline communications, and more specifically to power line communication (PLC) interference mitigation for digital subscriber line (DSL) networks.

### DESCRIPTION OF THE RELATED TECHNOLOGY

The rapid growth of the Internet and the content available through the Internet has increased the demand for high bandwidth connectivity. DSL technology (or xDSL) meets this demand by providing data service over twisted pair telephone lines. DSL can be deployed from central offices (COs), from fiber-fed cabinets located near the customer premises, or within buildings. DSL networks typically include multiple bundles of twisted pair wires located within proximity to each other. In some implementations, signals on the twisted pair may be impacted by other wireline communications systems, such as PLC networks. PLC networks utilize electrical wiring within a building as network cables to carry communications between PLC devices. For instance, power lines may be used to transmit and receive modulated data between PLC-capable devices that are connected to the power lines. However, the PLC signals carried on the power lines may create electromagnetic interference, resulting in noise received on the twisted pair of a collocated DSL network, thereby disrupting communications in the DSL network.

In some implementations, noise received on the DSL twisted pair may be measured and provided to an arbiter in communication with the PLC network or with one or more PLC devices of the PLC network. The noise may be measured with respect to each PLC device individually, which may involve halting communication from other PLC devices. Such measuring techniques may therefore introduce latency, as a result, DSL and PLC networks may benefit from techniques that enhance interoperability and improve PLC interference measurements on DSL lines.

### SUMMARY

The systems, methods and devices of this disclosure each have several innovative aspects, no single one of which is solely responsible for the desirable attributes disclosed herein.

One innovative aspect of the subject matter described in this disclosure can be implemented in an apparatus for wireline communication, including a processor, a memory in electronic communication with the processor, and instructions stored in the memory. The instructions can be operable, when executed by the processor, to cause the apparatus to detect that a power line communications (PLC) network is operating concurrently with a digital subscriber line (DSL) network; measure, at a DSL device of the DSL network, aggregate network interference from two or more PLC devices of the PLC network; determine a mitigation parameter for the two or more PLC devices based at least in part on the aggregate network interference; and apply the mitigation parameter to each PLC device of the two or more PLC devices.

In some implementations, the instructions can be further executable by the processor to perform a subsequent measurement of the aggregate network interference and adjust the mitigation parameter for a subset of the two or more PLC devices based at least in part on the subsequent measurement.

In some implementations, the instructions can be further executable by the processor to increase a power configuration for the subset of the two or more PLC devices based at least in part on the aggregate network interference or the subsequent measurement of the aggregate network interference.

In some implementations, the aggregate network interference can be measured while each PLC device of the two or more PLC devices are actively communicating.

In some implementations, the mitigation parameter can be determined and applied by an arbitration function, wherein the DSL device includes the arbitration function.

In some implementations, the instructions can be further executable by the processor to determine interference associated with an individual PLC device of the two or more PLC devices based at least in part on the aggregate network interference and determine an individual mitigation parameter for the individual PLC device based at least in part on the interference associated with the individual PLC device.

In some implementations, the instructions executable by the processor to detect that the PLC network is operating concurrently with the DSL network can further include instructions executable by the processor to identify, by the DSL device, the two or more PLC devices of the PLC network.

Another innovative aspect of the subject matter described in this disclosure can be implemented in a method for wireline communication, including detecting that a power line communications (PLC) network is operating concurrently with a digital subscriber line (DSL) network; measuring, at a DSL device of the DSL network, aggregate network interference from two or more PLC devices of the PLC network; determining a mitigation parameter for the two or more PLC devices based at least in part on the aggregate network interference; and applying the mitigation parameter to each PLC device of the two or more PLC devices.

In some implementations, the method can further include performing a subsequent measurement of the aggregate network interference and adjusting the mitigation parameter for a subset of the two or more PLC devices based at least in part on the subsequent measurement.

In some implementations, the method can further include increasing a power configuration for the subset of the two or more PLC devices based at least in part on the aggregate network interference or the subsequent measurement of the aggregate network interference.

In some implementations, applying the mitigation parameter can include transmitting the mitigation parameter to each PLC device of the two or more PLC devices.

In some implementations, detecting that the PLC network is operating concurrently with the DSL network can include identifying, by the DSL device, the two or more PLC devices of the PLC network.

In some implementations, the aggregate network interference can be measured while each PLC device of the two or more PLC devices is communicating

In some implementations, the mitigation parameter can be determined and applied by an arbitration function, wherein the DSL device includes the arbitration function

In some implementations, the method can further include determining interference associated with an individual PLC device of the two or more PLC devices based at least in part on the aggregate network interference and determining an individual mitigation parameter for the individual PLC device based at least in part on the interference associated with the individual PLC device.

In some implementations, measuring the aggregate network interference can include measuring signals from multiple PLC devices of the two or more PLC devices.

In some implementations, detecting that the PLC network is operating concurrently with the DSL network can include identifying, by the DSL device, the two or more PLC devices of the PLC network.

Another innovative aspect of the subject matter described in this disclosure can be implemented in an apparatus for wireline communication, including means for detecting that a power line communications (PLC) network is operating concurrently with a digital subscriber line (DSL) network; means for measuring, at a DSL device of the DSL network, aggregate network interference from two or more PLC devices of the PLC network; means for determining a mitigation parameter for the two or more PLC devices based at least in part on the aggregate network interference; and means for applying the mitigation parameter to each PLC device of the two or more PLC devices.

In some implementations, the apparatus can further include means for performing a subsequent measurement of the aggregate network interference and means for adjusting the mitigation parameter for a subset of the two or more PLC devices based at least in part on the subsequent measurement.

In some implementations, the apparatus can further include means for increasing a power configuration for the subset of the two or more PLC devices based at least in part on the aggregate network interference or the subsequent measurement of the aggregate network interference.

In some implementations, the means for applying the mitigation parameter can include means for transmitting the mitigation parameter to each PLC device of the two or more PLC devices.

In some implementations, the aggregate network interference can be measured while each PLC device of the two or more PLC devices is communicating

In some implementations, the mitigation parameter can be determined and applied by an arbitration function, wherein the DSL device includes the arbitration function

In some implementations, the apparatus can further include means for determining interference associated with an individual PLC device of the two or more PLC devices based at least in part on the aggregate network interference and means for determining an individual mitigation parameter for the individual PLC device based at least in part on the interference associated with the individual PLC device.

In some implementations, the means for measuring the aggregate network interference can include means for measuring signals from multiple PLC devices of the two or more PLC devices.

In some implementations, the means for detecting that the PLC network is operating concurrently with the DSL network can include means for identifying, by the DSL device, the two or more PLC devices of the PLC network.

Another innovative aspect of the subject matter described in this disclosure can be implemented in a method for wireline communications, including performing, by a first power line communications (PLC) device of a PLC network, communications with a second PLC device; refraining from entering a measurement mode prior to receiving a mitigation parameter; receiving, at the first PLC device, the mitigation parameter based at least in part on the performed communications; and applying, at the first PLC device, the mitigation parameter for subsequent communications with the second PLC device.

In some implementations, the method can further include performing subsequent communications with the second PLC device based at least in part on the applied mitigation parameter.

In some implementations, the method can further include receiving an adjust mitigation parameter based at least in part on the subsequent communications and applying the adjusted mitigation parameter for additional communications with the second PLC device.

In some implementations, refraining from entering the measurement mode prior to receiving the mitigation parameter can include refraining from transmitting a measurement mode packet.

In some implementations, the mitigation parameter can include a power configuration common to each of the first PLC device and the second PLC device.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows an example communication environment for wireline communications supporting power line communication (PLC) interference mitigation for digital subscriber line (DSL) networks.

FIG. 2 shows an example communication environment supporting PLC interference mitigation for DSL networks.

FIG. 3 shows an example wireline communications networks supporting PLC interference mitigation for DSL networks.

FIG. 4 shows an example process flow of PLC interference mitigation for DSL networks.

FIG. 5 shows an example device supporting PLC interference mitigation for DSL networks.

FIG. 6 shows an example device supporting PLC interference mitigation for DSL networks.

FIG. 7 shows an example communications manager supporting PLC interference mitigation for DSL networks.

FIG. 8 shows an example device that supports PLC interference mitigation for DSL networks.

FIG. 9 shows an example device that supports PLC interference mitigation for DSL networks.

FIG. 10 shows an example device that supports PLC interference mitigation for DSL networks.

FIG. 11 shows an example PLC communications manager 1115 supporting PLC interference mitigation for DSL networks.

FIG. 12 shows an example device that supports PLC interference mitigation for DSL networks.

FIGS. 13-16 show example methods for PLC interference mitigation for DSL networks.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving wireline signals according to any of the International Telecommunication Union Telecommunication Standardization Sector (ITU-T) standards and recommendations, any of the High Definition Power Line Communication (HD-PLC) Alliance standards or recommendations, or any of the HomePlug Audio Video (HPAV) standards, or other known signals that are used to communicate within a wireline network.

The described techniques relate to power line communication (PLC) interference mitigation for digital subscriber line (DSL) networks. Generally, the described techniques provide for the detection of a PLC network operating concurrently with a DSL network. Interference at a DSL device within the DSL network caused by two or more PLC devices of the PLC network may be measured. For example, a DSL device may detect interference on a set of DSL lines caused by multiple PLC devices of the PLC network. The DSL device may measure the aggregate interference from the multiple PLC devices to determine a mitigation parameter (such as a back-off parameter) for the PLC network. The aggregate interference may be measured while the set of PLC devices are actively communicating. In some implementations, the DSL device may communicate the measured aggregate network interference to an arbiter, and the arbiter may determine the mitigation parameter. The measured aggregate network interference may be used to determine a single mitigation parameter to be applied to the PLC network such that each PLC device of the set of PLC devices operates according to the same mitigation parameter.

Additionally, or alternatively, one or more subsequent measurements of the PLC network may be performed (such as by the DSL device) and the determined mitigation parameter may be adjusted based on the subsequent measurements. For instance, two or more PLC devices may be operating according to a first determined mitigation parameter (such as determined by an arbiter based on an aggregate interference of the PLC network). A DSL device may perform a subsequent measurement of the PLC network, which may be used to adjust the previously determined mitigation parameter or determine a new mitigation parameter. In some implementations, the DSL device may communicate the one or more subsequent measurements to an arbiter, which may determine or adjust the mitigation parameter. The mitigation parameter may be applied to the PLC network such that multiple devices of the PLC network apply the same mitigation parameter.

Particular implementations of the subject matter described in this disclosure can be implemented to realize one or more of the following potential advantages. Measurement of aggregate interference from a PLC network may be performed to determine a mitigation parameter for mitigating PLC interference at a DSL device. Rather than measuring interference for each PLC device individually and determining a respective mitigation parameter for each PLC device, measurement of the aggregate interference may be performed while multiple PLC devices of the PLC network are actively communicating. Accordingly, PLC devices of the PLC network do not have to halt active communications (such as during a measurement period) when interference measurements are being performed and such techniques may reduce PLC network downtime. In some implementations, PLC devices of the PLC network may remain in idle mode when interference measurements are being performed. To account for changing network conditions, subsequent measurements of the PLC network may be performed to determine or adjust the mitigation parameter. Therefore, such techniques may allow for reduced latency and improved network performance through aggregate interference measurements of a PLC network and application of a single mitigation parameter to multiple PLC devices.

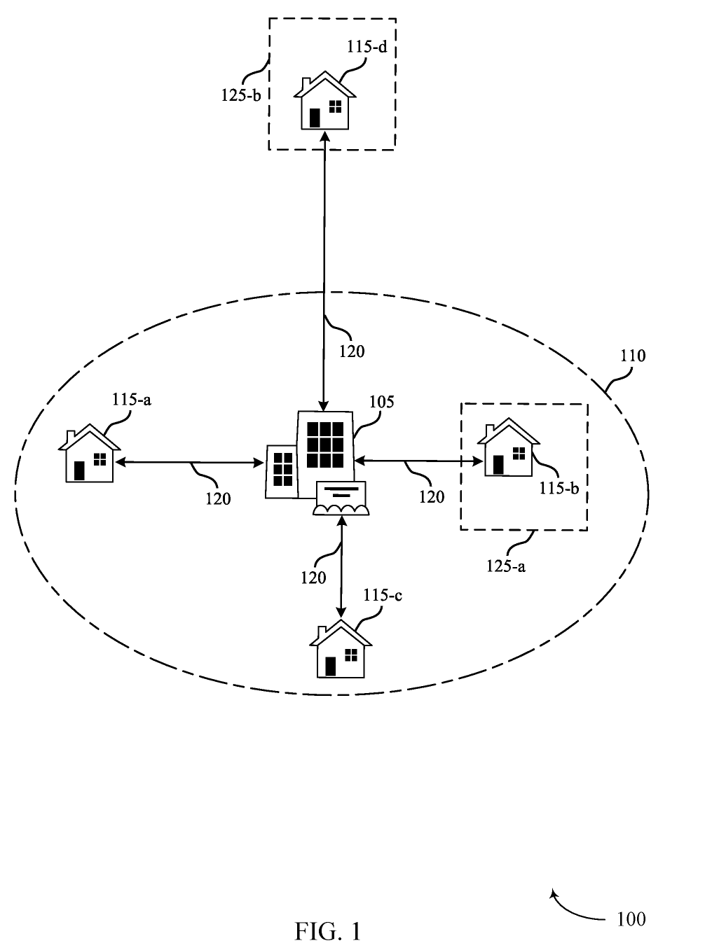

FIG. 1 illustrates an example communication environment 100 supporting PLC interference mitigation for DSL networks. As shown, the communication environment 100 includes a central office (CO) 105, which may provide a DSL line for a DSL network to the multiple homes 115. The DSL network may be deployed via the communication links 120 from fiber-fed cabinets located near the customer premises or within buildings. The DSL networks may include multiple bundles of twisted pair wires located within proximity to each other and in some implementations, signals communicated on the twisted pair (such as via the communication link 120) may be impacted by other wireline communications systems, such as a PLC network.

Multiple networks may coexist at one or more homes 115 within communication environment 100. For example, home 115-b may have a collocated network 125-a that includes a DSL network and a PLC network, or other communication networks. PLC networks may interfere with DSL networks (such as due to the use of overlapping frequencies by both networks) and although both networks separately communicate over dedicated wirelines, cabling used for communications may not be shielded. In such instances, signals may radiate or leak across wired mediums in both directions.

Electromagnetic interference caused by PLC signals carried on power lines may result in noise received on the twisted pair of a collocated DSL network, thereby disrupting communications in the DSL network. Such disruption may be negligible within CO coverage area 110, as DSL signal strength within CO coverage area may be strong, but as the distance from the CO increases, the interference from PLC signals may become more apparent. For example, the DSL network of collocated network 125-a in home 115-b may not be adversely affected by PLC interference as the DSL signal strength from the CO is much greater than the PLC interference (such as due to the proximity of home 115-b to the CO 105 within the CO coverage area 110). Homes 115-a and 115-c are also within the CO coverage area 110 and may receive strong DSL signals via respective communication links 120, but may not have any collocated networks. As such, homes 115-a, 115-b, and 115-c, may not perform any interference mitigation for PLC networks. Home 115-d, however, is shown having a collocated network 125-b (such as a PLC network and a DSL network) and is located outside of the CO coverage area 110. In such instances, the DSL signal may not be as strong and DSL communications may therefore be adversely affected by interference caused by PLC devices of the PLC network within the collocated network 125-b.

To help mitigate interference experienced at a DSL device of the DSL network, the DSL device may enter an interference mitigation mode (such as G.dpm mode). A higher layer connection such as an arbiter (or arbitration function) between the PLC network and the DSL network may be utilized to aide in the interference mitigation process performed by devices within the PLC network or the DSL network.

In some interference mitigation modes, such as G.dpm mode, interference from each PLC device of a PLC network may be measured separately by a customer premises equipment (CPE). A CPE may be located at a home 115 and may include a single DSL device connected to the CO (such as via communication link 120) and multiple PLC devices within or near the same home 115. To better distinguish the interference from background noise, the DSL connection remains idle during a period during which measurements are performed. In some implementations, a single PLC device of the PLC network may be communicating and the other PLC devices also may remain idle so that communications from PLC devices other than the PLC device subject to measurement do not impact the measurements. Once the interference information is known, an arbiter may determine and apply appropriate mitigation for each PLC device of the PLC network. Aspects of the present disclosure may allow interference to be measured from the PLC network as a whole, and mitigation to be derived from such measurement.

In some implementations, measurement of the PLC network is aggregated such that PLC devices of a PLC network within the collocated network 125-b are measured without interruption of communication. The measured aggregated value may be used to determine a single mitigation parameter to be applied to each PLC device of the PLC network. In some instances, the measuring of the PLC network and determination of the mitigation parameter may be iterative in that subsequent measurements of the PLC network may be used to adjust or determine a new mitigation parameter for mitigating PLC interference.

In some aspects, a measurement request may be used to enable a DSL CPE to make noise measurements while all PLC devices (including devices that have no traffic) are communicating. The measurement request may indicate a measurement period, during which the DSL CPE may make noise measurements of the PLC network. If the DSL CPE detects interference that may adversely affect DSL communications, a configure request, which may be determined by an arbiter, may be transmitted to the PLC network or to each PLC device of the PLC network and all PLC devices may comply with the configure request.

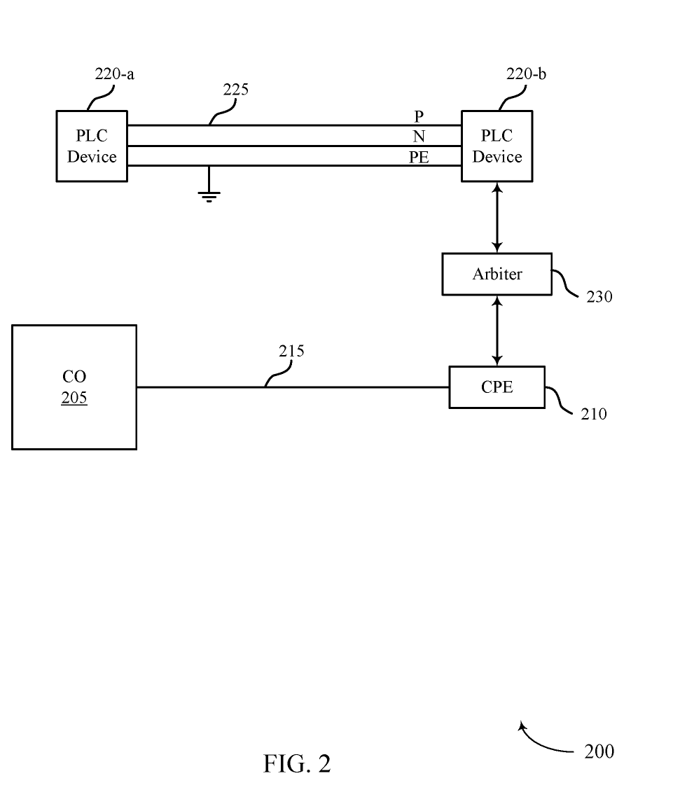

FIG. 2 illustrates an example collocated wireline communications system 200 supporting PLC interference mitigation for DSL networks. The collocated wireline communications systems 200 may be an example of the collocated networks 125, as described above with reference to FIG. 1. The collocated wireline communications systems 200 may include CPEs 210 communicatively coupled to a CO 205 via a cable binder (not shown) and an adjacent PLC network with multiple PLC devices 220 in communication with each other. For example, the collocated wireline communications systems 200 may include a CO 205 that is connected to a number of remote nodes, such as CPE 210. The CPE 210 may be communicatively coupled to the CO 205 via subscriber line 215, which may be an example of a communication link 120, as described with reference to FIG. 1. The subscriber line 215 may include, for example, one or more twisted-pair copper wire connections. A CPE 210 may include a modem, a transceiver, a computing device, or other types of communication devices, or combinations of such devices, which are configured to exchange (such as send or receive) data with the CO 205.

The adjacent PLC network within collocated wireline communications systems 200 may include PLC device 220-a and PLC device 220-b communicatively coupled via powerlines 225. The powerlines 225 may be, for example, lines carrying electricity within a building and may further be used to transmit and receive modulated data and control signals. For example, powerlines 225 may include a phase (P) line, a neutral (N) line, and a phase earth (PE) line used by PLC devices 220 for communication. The collocated wireline communications systems 200 also may include an arbiter 230 (or arbiter function (AF)) used to communicate with one or more CPEs 210 and one or more PLC devices 220. While the arbiter 230 is shown as a separate structure, the arbiter 230 may be located within a CPE 210 or other DSL device, such as a component of CPE 210. Additionally, or alternatively, the arbiter 230 may be part of a PLC network, or remotely connected to the PLC devices 220 and one or more CPEs 210, but not collocated with these devices. In some implementations, the collocated wireline communications systems 200 supports PLC interference measurement and mitigation in DSL subscriber lines.

A PLC device 220 may use a primary coupling (such as a coupling between a P line and a PE line, referred to as P-PE) or an alternate coupling (such as a coupling between the P and N) line, referred to as P-N) to communicate, where these coupling may create different interference on the DSL lines based on signal modulation. The different amounts of PLC signal interference associated with different transmission schemes may be due to constructive and destructive effects of primary and alternate couplings experienced by a DSL receiver. Varying PLC signal interference levels may be due to the use of different transmission schemes associated with the communication between PLC devices. Therefore, the PLC signal interference from different PLC devices may be measured aggregately, or as a whole, by the CPE 210 or arbiter 230.

Communications between the CO 205 and the CPE 210 include both downstream and upstream communications for each of the active subscriber lines 215. The downstream direction refers to the direction from the CO 205 to a CPE 210, and the upstream direction is the direction from the CPE 210 to the CO 205. Although not explicitly shown, each of the subscriber lines 215 may be coupled to a CO transmitter and a CPE receiver for use in communicating in the downstream direction, and a CPE transmitter and a CO receiver for use in communicating in the upstream direction. On both the CO 205 and CPE 210 side, hardware implementing both a transmitter and a receiver may be generically referred to as a modem or a transceiver.

In some implementations, communication signals from the PLC devices 220 may interfere with DSL signal reception. For example, as mentioned above, PLC networking over the powerlines 225 uses existing electrical wiring to carry data signals through the superposition of information signals onto power waves. The powerlines 225 may be unshielded and untwisted, which may cause electromagnetic fields from the information signals to be radiated away from the powerlines 225. The electromagnetic fields may exist for both differential mode (DM) and common mode (CM) currents that flow on the powerlines 225. These electromagnetic fields may couple into the subscriber lines 215 and flow toward the CPE 210, causing interference to a CPE 210. Another potential coupling point may be through a power supply unit (PSU) of a CPE 210. For example, the PSU may have limited CM signal rejection and a CM signal originating from a PLC network may thus produce a CM signal on the subscriber lines 215 that flows away from the CPE 210. In some implementations, multiple coupling points may exist between the powerlines 225 and the subscriber lines 215.

CM interference may be converted to DM noise due to imbalances associated with the subscriber lines 215 with respect to a common ground. For example, if a subscriber line 215 is properly balanced (perfect twist) with respect to ground and a CPE 210 has large CM signal rejection on a line side, the CM interference may not produce any DM noise. However, if any imbalance with respect to ground exists on the subscriber lines 215 or the CPE 210 does not have perfect CM signal rejection, at least a portion of the CM signal may be converted to DM noise (where the amount may depend on where the CM signal coupling occurs). Thus, PLC signals that are coupled to a DSL network in CM may appear as DM noise on the DSL network.

The CPE 210 may measure aggregate PLC signal interference on subscriber lines 215. For example, a CPE 210 may detect noise on subscriber lines 215. The CPE 210 may measure aggregate PLC signal interference on the subscriber lines 215 based on the detected noise. In some implementations, the CPE 210 may communicate the measured PLC signal interference to the arbiter 230, which may determine a mitigation parameter to apply to each PLC device 220. The mitigation parameter (such as back-off value) for each PLC device may initially be the same, but subsequent measurements of the PLC network or one or more PLC devices 220 of the PLC network may be used to adjust mitigation parameter(s) for one or more PLC devices 220 of the PLC network.

Mitigating interference based on multiple PLC devices in the PLC network may initially impact performance (such as due to a single mitigation parameter applied to all PLC devices), but some homes may not experience interference between the PLC network and the DSL network and performance would not be affected in these homes. In addition, interference from multiple PLC devices may be measured without the use of specific signals or time periods solely dedicated for performing measurements, which may result in less overall downtime and increased performance for both the PLC network and the DSL network. Further, some PLC networks contain a few devices and iterative optimization of the mitigation parameter may be sufficiently effective without impacting performance. In some instances, mitigation may be limited to the frequency range of interference. For example, a portion of the PLC frequency band may overlap with the DSL frequency band and mitigation may be applied to the overlapping frequency range. In such cases, the remaining portion of the PLC frequency band may be used without mitigation. According to some aspects, during interference measurement, PLC devices at the DSL CPE do not need to be identified individually, hence measurements of the PLC network and multiple PLC devices may be performed more quickly (such as 1 measurement of the PLC network, as opposed to N measurement of NPLC devices). Moreover, measurements may not utilize dedicated special ‘training packets’ that would cause downtime to PLC network operations. Instead, measurements may be performed based on active regular PLC data transmissions.

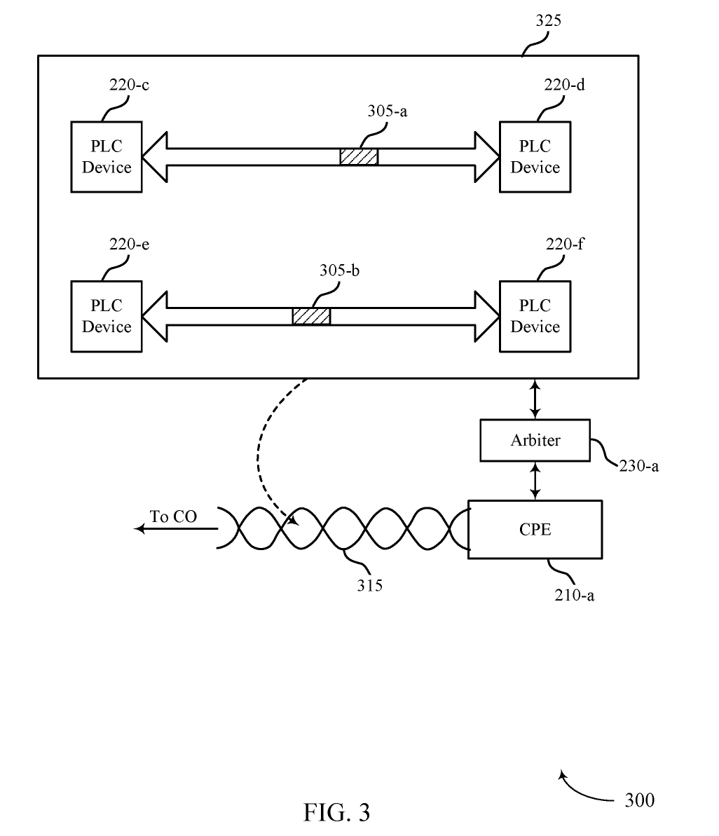

FIG. 3 illustrates an example collocated wireline communications system 300 supporting PLC interference mitigation for the DSL networks. In some implementations, the collocated wireline communications system 300 may implement aspects of the communication environment 100.

The collocated wireline communications system 300 may include a CPE 210-a communicating with a CO (such as CO 205 of FIG. 2) over a set of DSL lines, such as a twisted pair 315, which may be an example of communication link 120 or subscriber line 215, as described with reference to FIGS. 1 and 2. Additionally, the CPE 210-a may be located near or within the same premises as a PLC network 325 (i.e., collocated) and may include multiple PLC devices 220 (such as PLC devices 220-c, 220-d, 220-e, and 220-f). The CPE 210-a and the PLC devices 220 may be examples of the corresponding devices as described with reference to FIG. 2. The collocated wireline communications systems 300 may be an example of a system that enables the efficient measurement and mitigation of PLC signal interference into DSL subscriber lines through the detection of aggregate PLC interference.

In the collocated wireline communications systems 300, the PLC transmissions 305 may be used to detect PLC network interference on the twisted pair 315. For example, the PLC transmission 305-a may be transmitted by PLC device 220-c to PLC device 220-d. In addition, the PLC transmission 305-b may be transmitted by the PLC device 220-e to the PLC device 220-f. In some implementations, the aggregate noise from the PLC transmissions 305 within the PLC network 325 may be detected on the twisted pair 315 by the CPE 210-a.

In some implementations, the PLC transmissions 305 used for measuring aggregate PLC network interference on the twisted pair 315 may be transmitted by a PLC device 220 using medium access control (MAC) protocol data unit (MPDU) bursting. For example, MPDU bursting is a process in which a PLC device 220 transmits multiple MPDUs in a burst (without relinquishing the medium), which allows the PLC device 220 to transmit PLC transmissions 305 almost continuously. The near-continuous transmission of the PLC transmissions 305 may enable efficient measurement of aggregate PLC network interference on the twisted pair 315 by ensuring that all PLC devices 220 are operating normally, allowing for reception and transmission of PLC communications.

The PLC device 220-c may produce different PLC signal interference on the twisted pair 315 when participating in point-to-point communication with PLC device 220-d than a PLC device 220-e communicating with PLC device 220-f. The different PLC signal interference may be due to the use of different transmission schemes (such as spot beamforming or eigenvalue precoding) associated with the communication. The different transmission schemes may result in different levels of constructive or destructive interference of a PLC network, which may be seen as different levels of PLC signal interference on the twisted pair 315. Therefore, the described techniques allow the aggregate PLC network interference from different PLC devices 220 to be measured without consideration of how the PLC transmissions 305 have been transmitted or which PLC transmissions 305 results in specific interference.

In some implementations, an arbiter 230-a may be used to facilitate measurement of aggregate PLC network interference on twisted pair 315. In some implementations, the arbiter 230-a may be a component of the CPE 210-a, a component of a PLC device 220, implemented using components of both the CPE 210-a and one or more PLC devices 220, or a standalone device in communication with both the CPE 210-a and the PLC network 325.

The arbiter 230-a may instruct the CPE 210-a to perform measurements of aggregate PLC network interference after detecting interference from one or more PLC devices 220 (such as due to PLC transmissions 305). Aggregate PLC network interference measurements on the twisted pair 315 may subsequently be provided to the arbiter 230-a by the CPE 210-a. In some implementations, the arbiter 230-a also may communicate operating parameters to the CPE 210-a based on an expected or measured aggregate PLC network interference. Additionally, or alternatively, the arbiter 230-a may communicate operating conditions (such as transmission power back-off) to the PLC network devices 220. For example, the arbiter 230-a may communicate operating conditions to the PLC network 325 as a whole, as a subset of PLC devices 220, or each PLC device individually.

In some implementations, a transmission power level of the PLC transmissions 305 may be adjusted during multiple measurement processes. For instance, after an initial determination of transmission power level for PLC transmissions 305, a mitigation parameter (such as transmission power back-off) may be applied to subsequent PLC transmissions 305 after a power back-off level is determined. The power back-off level may be determined based on measurements of the aggregate PLC network interfering with the twisted pair 315.

For example, the arbiter 230-a may communicate the determined network back-off to the PLC network 325 or to a subset of PLC devices 220 that support the coexistence of the PLC network and the DSL network based on the measurement(s) completed by the CPE 210-a. In some implementations, the back-off may be the same for multiple PLC devices 220 in the PLC network 325. Another channel estimation process may be completed by applying the desired power back-off level and measuring the PLC signal interference again. In some implementations, the power back-off may be applied independently to PLC transmissions 305 transmitted on different couplings (such as different power back-off levels applied to primary and alternate couplings).

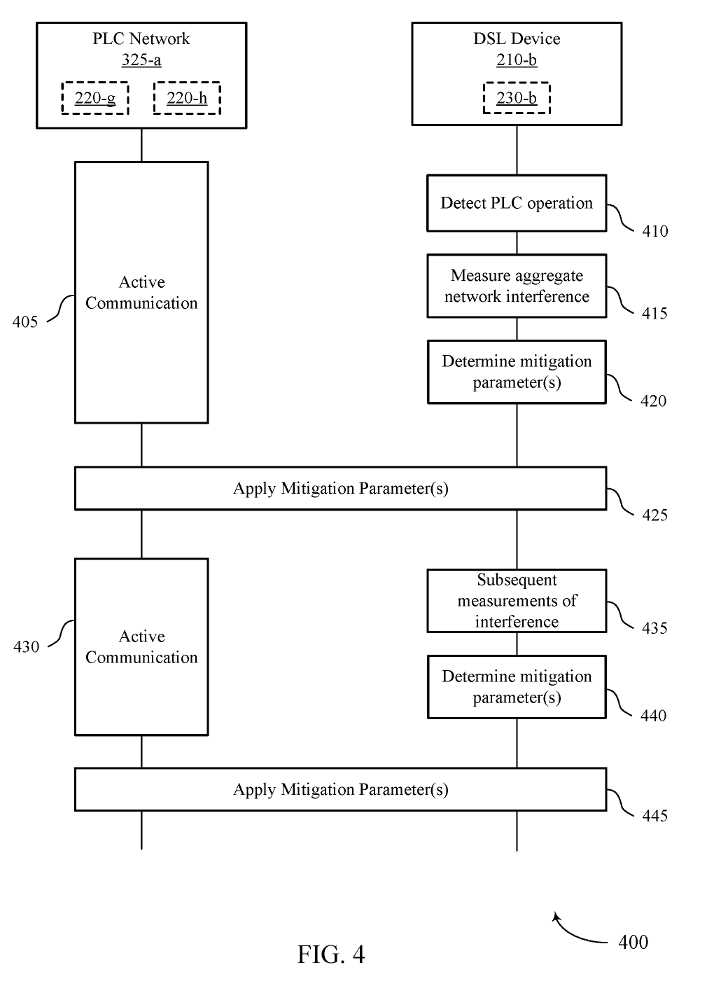

FIG. 4 illustrates an example process flow 400 of PLC interference mitigation for DSL networks. In some implementations, the process flow 400 may implement aspects of the communication environment 100, or the collocated wireline communications systems 200, 300, as described above with reference to FIGS. 1 through 3. The process flow 400 may include processes performed by the PLC network 325-a, the PLC devices 220-g and 220-h, the DSL device 210-b, and the arbiter 230-b as described with reference to FIGS. 1-3. The PLC devices 220-g and 220-h may be components of the PLC network 325-a. The arbiter 230-b may be a component of the DSL device 210-b. The process flow 400 may be an example interference mitigation procedure for the DSL devices collocated with a PLC network.

At 405, the PLC devices 220-g and 220-h may actively communication on the PLC network 325-a. Active communication may include receiving and transmitting data communications independently of actions occurring at other communication devices, for example, the DSL device 210-b.

At 410, the DSL device 210-b may detect the concurrent operation of a collocated PLC network 325-a. In some implementations, the arbiter 230-b may detect the aggregate interference from the PLC network 325-a and trigger an interference mitigation procedure at the DSL device 210-b.

At 415, the DSL device 210-b may measure the aggregate network interference. In some implementations, the aggregate network interference is from two or more PLC devices 220-g and 220-h of the PLC network 325-a.

At 420, the DSL device 210-b may determine mitigation parameter(s) for the set of PLC devices. In some implementations, the mitigation parameter(s) is based at least in part on the aggregate network interference. An example mitigation parameter may include a transmission power back-off of the PLC network 325-a. In some implementations, the back-off may be the same for multiple PLC devices 220-g and 220-h in the PLC network 325-a.

At 425, the mitigation parameter(s) may be applied to the PLC network 325-a. In some implementations, the arbiter 230-b may communicate the determined network back-off to the PLC network 325-a or to a subset of PLC devices 220 that support the coexistence of the PLC network and the DSL network based on the measurement(s) completed by the DSL device 210-b. In some other implementations, the DSL device 210-b, PLC network 325-a, or PLC devices 220-g and 220-h may apply the mitigation parameter to each PLC device 220-g and 220-h. In some implementations, the mitigation parameter may be a transmission power back-off of the PLC network 325-a. In some implementations, the back-off may be the same for multiple PLC devices 220-g and 220-h (among others) in the PLC network 325-a.

At 430, the PLC devices 220-g and 220-h may actively communicate on the PLC network 325-a according to the mitigation parameter. Active communication may include receiving and transmitting data communications. In some implementations, subsequent measurements of the PLC network 325-a may be measured at 435 to determine or adjust the mitigation parameter(s). For example, the DSL device 210-b or the arbiter 230-b may perform subsequent measurements of interference during active communication 430. The subsequent measurements may be performed for a single PLC device 220-g or 220-h or may be for all devices of the PLC network 325-a (such as both of PLC device 220-g and PLC device 220-h).

Based on the subsequent measurements, a new mitigation parameter for one or both of PLC device 220-g and PLC device 220-h may be determined or the mitigation parameter determined at 420 may be adjusted for one or both of PLC device 220-g and PLC device 220-h. In some implementations, the mitigation parameter(s) is based at least in part on the aggregate network interference. An example mitigation parameter may include a transmission power back-off of the PLC network 325-a. In some implementations, the back-off may be the same for multiple PLC devices 220-g and 220-h in the PLC network 325-a or may be different for one or more of PLC devices 220-g and 220-h in the PLC network 325-a.

At 445, the new or adjusted mitigation parameter(s) may be applied to the PLC network 325-a. In some implementations, the arbiter 230-b may communicate the determined network back-off to the PLC network 325-a or to a subset of PLC devices 220 that support the coexistence of the PLC network and the DSL network based on the measurement(s) performed at 435 (such as by the DSL device 210-b). In some other implementations, the DSL device 210-b, PLC network 325-a, or PLC devices 220-g and 220-h may apply the mitigation parameter to each PLC device 220-g and 220-h. In some implementations, the mitigation parameter may be a transmission power back-off of the PLC network 325-a. In some implementations, the back-off may be the same for multiple PLC devices 220-g and 220-h (among others) in the PLC network 325-a.

The PLC network 325-a and devices 220-g and 220-h may be unaware of portions or the entire interference mitigation procedure. For example, operations 410, 415, 420, 435, or 440 may be performed independently from the status or awareness of the PLC network 325-a. In some implementations, active communication at the PLC network 325-a may pause to update mitigation parameter(s) (such as during the application of mitigation parameter(s) at 425 or 445).

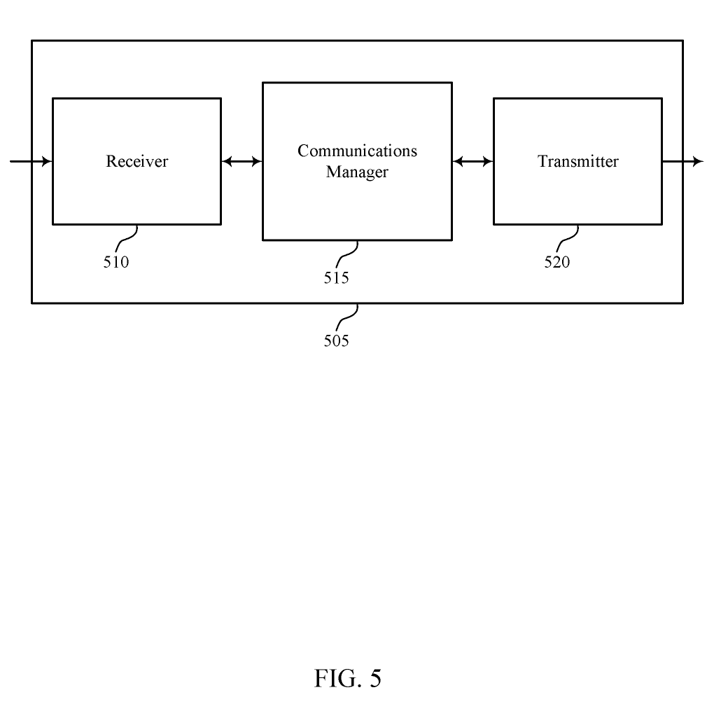

FIG. 5 shows an example device 505 supporting PLC interference mitigation for DSL networks. The device 505 may be an example of aspects of a CPE 210 or an arbiter 230 as described herein. The device 505 may include a receiver 510, a communications manager 515, and a transmitter 520. The device 505 also may include a processor. Each of these components may be in communication with one another (such as via one or more buses).

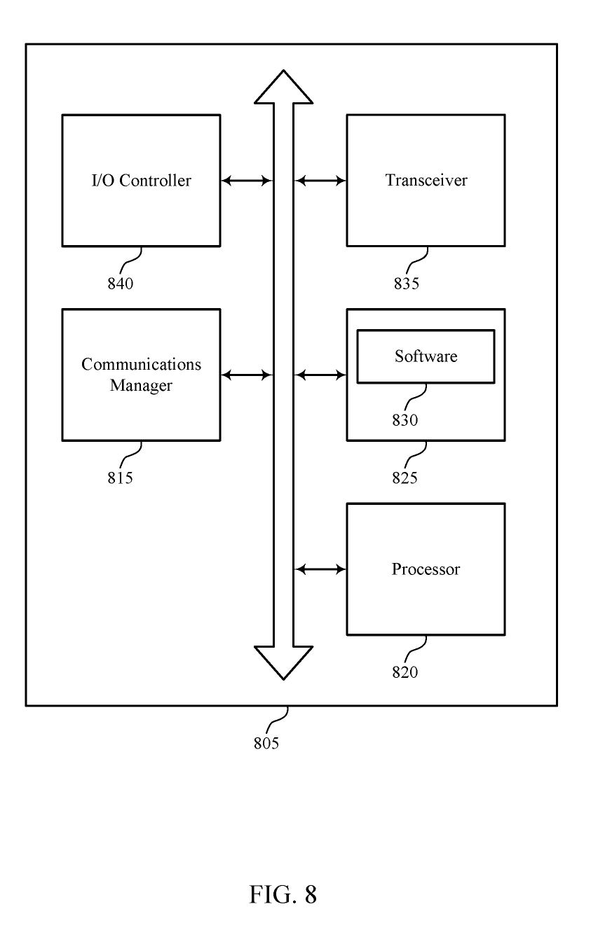

The receiver 510 may receive information such as packets, user data, or control information associated with various information channels (such as control channels, data channels, and information related to PLC interference mitigation for DSL networks, etc.). Information may be passed on to other components of the device. The receiver 510 may be an example of aspects of the transceiver 835 described with reference to FIG. 8. The receiver 510 may utilize a single antenna or a set of antennas.

The communications manager 515 or at least some of its various sub-components may be physically located at various positions, including being distributed such that portions of functions are implemented at different physical locations by one or more physical devices. In some implementations, the communications manager 515 or at least some of its various sub-components may be a separate and distinct component in accordance with various aspects of the present disclosure. In some other implementations, the communications manager 515 or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

The communications manager 515 may detect that a PLC network is operating concurrently with a DSL network, measure, at a DSL device of the DSL network, aggregate network interference from two or more PLC devices of the PLC network, determine a mitigation parameter for the set of PLC devices based on the aggregate network interference, and apply the mitigation parameter to each PLC device of the set of PLC devices.

The transmitter 520 may transmit signals generated by other components of the device. In some implementations, the transmitter 520 may be collocated with a receiver 510 in a transceiver module. For example, the transmitter 520 may be an example of aspects of the transceiver 835 described with reference to FIG. 8. The transmitter 520 may utilize a single antenna or a set of antennas.

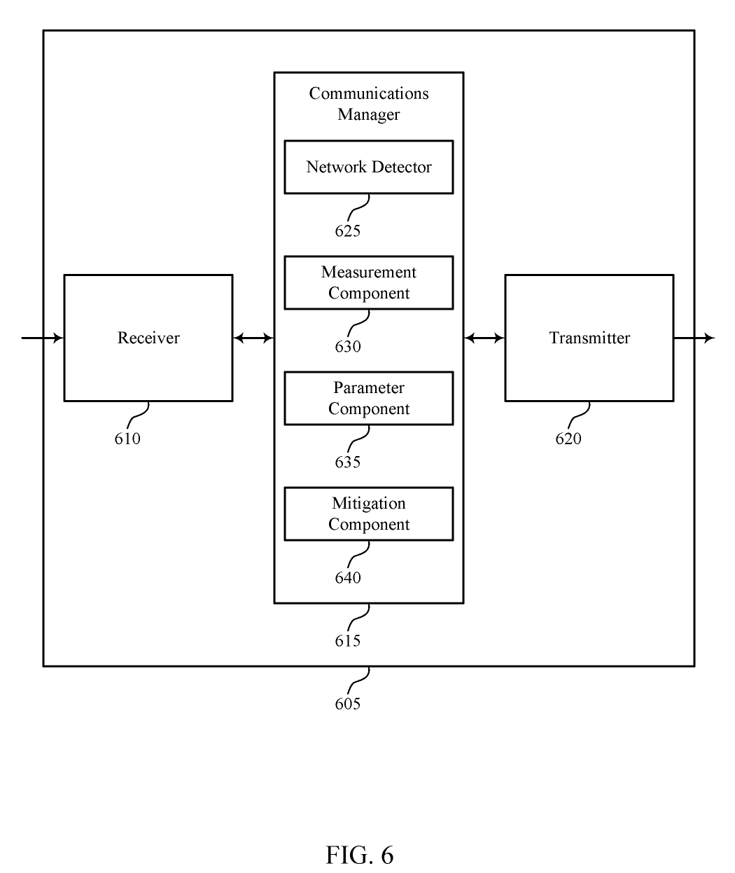

FIG. 6 shows an example device 605 supporting PLC interference mitigation for DSL networks. The device 605 may be an example of aspects of a device 505, a CPE 210, or an arbiter 230 as described with reference to FIG. 5. The device 605 may include a receiver 610, a communications manager 615, and a transmitter 620. The device 605 also may include a processor. Each of these components may be in communication with one another (such as via one or more buses).

The receiver 610 may receive information such as packets, user data, or control information associated with various information channels (such as control channels, data channels, and information related to PLC interference mitigation for DSL networks, etc.). Information may be passed on to other components of the device. The receiver 610 may be an example of aspects of the transceiver 835 described with reference to FIG. 8. The receiver 610 may utilize a single antenna or a set of antennas.

The communications manager 615 may be an example of aspects of the communications manager 815 described with reference to FIG. 8. The communications manager 615 also may include network detector 625, measurement component 630, parameter component 635, and mitigation component 640.

The network detector 625 may detect that a PLC network is operating concurrently with a DSL network. In some implementations, detecting that the PLC network is operating concurrently with the DSL network includes: identifying, by the DSL device, the set of PLC devices of the PLC network.

The measurement component 630 may measure, at a DSL device of the DSL network, aggregate network interference from two or more PLC devices of the PLC network and perform a subsequent measurement of the aggregate network interference. In some implementations, the aggregate network interference is measured while two or more PLC device of the set of PLC devices are communicating. In some implementations, measuring the aggregate network interference includes measuring signals from multiple PLC devices of the set of PLC devices.

The parameter component 635 may determine a mitigation parameter for the set of PLC devices based on the aggregate network interference. In some implementations, the mitigation parameter is determined and applied by an arbitration function implemented by the DSL device.

The mitigation component 640 may apply the mitigation parameter to each PLC device of the set of PLC devices, adjust the mitigation parameter for a subset of PLC devices based on the subsequent measurement, and adjust the mitigation parameter based on the interference associated with the individual PLC device. In some implementations, applying the mitigation parameter includes: transmitting the mitigation parameter to each PLC device of the set of PLC devices.

The transmitter 620 may transmit signals generated by other components of the device. In some implementations, the transmitter 620 may be collocated with a receiver 610 in a transceiver module. For example, the transmitter 620 may be an example of aspects of the transceiver 835 described with reference to FIG. 8. The transmitter 620 may utilize a single antenna or a set of antennas.

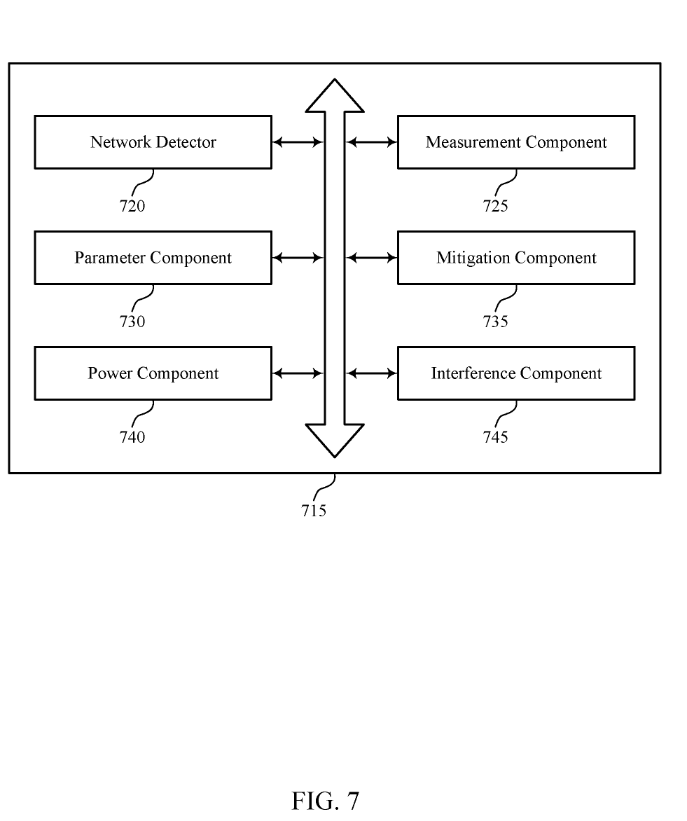

FIG. 7 shows a communications manager 715 supporting PLC interference mitigation for DSL networks. The communications manager 715 may be an example of aspects of the communications manager 515, the communications manager 615, or the communications manager 815 described with reference to FIGS. 5, 6, and 8. The communications manager 715 may include a network detector 720, a measurement component 725, a parameter component 730, a mitigation component 735, a power component 740, and an interference component 745. Each of these modules may communicate, directly or indirectly, with one another (such as via one or more buses).

The network detector 720 may detect that a PLC network is operating concurrently with a DSL network. In some implementations, detecting that the PLC network is operating concurrently with the DSL network includes identifying, by the DSL device, the set of PLC devices of the PLC network.

The measurement component 725 may measure, at a DSL device of the DSL network, aggregate network interference from two or more PLC devices of the PLC network and perform a subsequent measurement of the aggregate network interference. In some implementations, the aggregate network interference is measured while each PLC device of the set of PLC devices is communicating. In some implementations, measuring the aggregate network interference includes measuring signals from multiple PLC devices of the set of PLC devices.

The parameter component 730 may determine a mitigation parameter for the set of PLC devices based on the aggregate network interference. In some implementations, the mitigation parameter is determined and applied by an arbitration function implemented by the DSL device.

The mitigation component 735 may apply the mitigation parameter to each PLC device of the set of PLC devices, adjust the mitigation parameter for a subset of PLC devices based on the subsequent measurement, and adjust the mitigation parameter based on the interference associated with the individual PLC device. In some implementations, applying the mitigation parameter includes transmitting the mitigation parameter to each PLC device of the set of PLC devices.

The power component 740 may increase a power configuration for the subset of PLC devices based on the aggregate network interference or the subsequent measurement of the aggregate network interference.

The interference component 745 may determine interference associated with an individual PLC device of the set of PLC devices based on the aggregate network interference.

FIG. 8 illustrates an example device 805 that supports PLC interference mitigation for DSL networks. The device 805 may be an example of or include the components of device 505, device 605, a CPE 210, or an arbiter 230 as described above, such as with reference to FIGS. 5 and 6. The device 805 may include components for bi-directional voice and data communications including components for transmitting and receiving communications, including a communications manager 815, a processor 820, a memory 825, software 830, a transceiver 835, and an I/O controller 840. These components may be in electronic communication via one or more buses (such as bus 810).

The processor 820 may be configured to execute computer-readable instructions in the software 830 stored in the memory 825 to perform functions or tasks supporting PLC interference mitigation for DSL networks.

The transceiver 835 may communicate bi-directionally, via one or more wireline links as described above. For example, the transceiver 835 may represent a wireline transceiver and may communicate bi-directionally with another wireline transceiver. The transceiver 835 also may include a modem to modulate the packets and provide the modulated packets to the antennas for transmission, and to demodulate packets received from the wireline links as described above.

The I/O controller 840 may manage input and output signals for the device 805. The I/O controller 840 also may manage peripherals not integrated into the device 805. In some implementations, the I/O controller 840 may represent a physical connection or port to an external peripheral. In some implementations, the I/O controller 840 may utilize an operating system such as iOS®, ANDROID®, MS-DOS®, MS-WINDOWS®, OS/2®, UNIX®, LINUX®, or another known operating system. In some other implementations, the I/O controller 840 may represent or interact with a modem, a keyboard, a mouse, a touchscreen, or a similar device. In some implementations, the I/O controller 840 may be implemented as part of the processor 820. In some implementations, a user may interact with the device 805 via the I/O controller 840 or via hardware components controlled by the I/O controller 840.

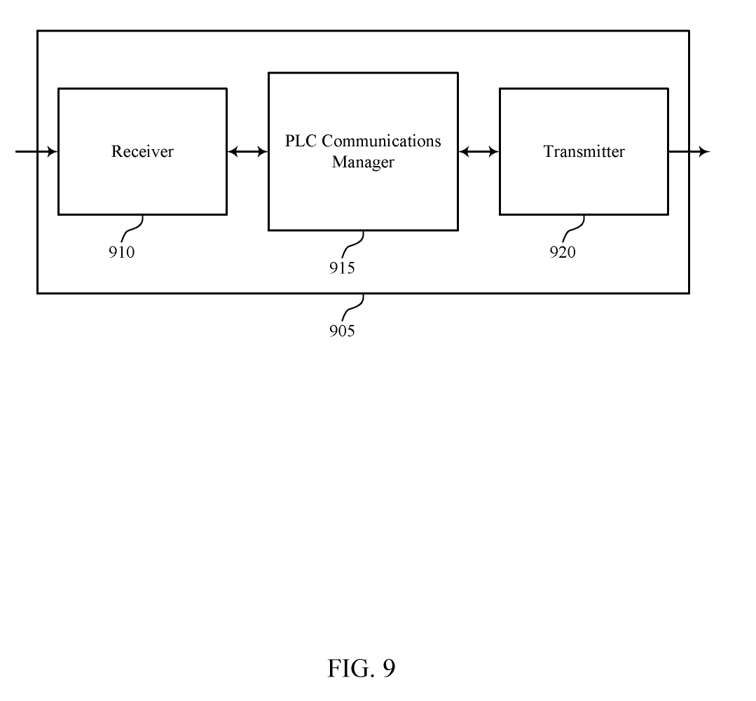

FIG. 9 shows an example device 905 that supports PLC interference mitigation for DSL networks. The device 905 may be an example of aspects of a PLC device as described herein. The device 905 may include a receiver 910, a PLC communications manager 915, and a transmitter 920. The device 905 also may include a processor. Each of these components may be in communication with one another (such as via one or more buses).

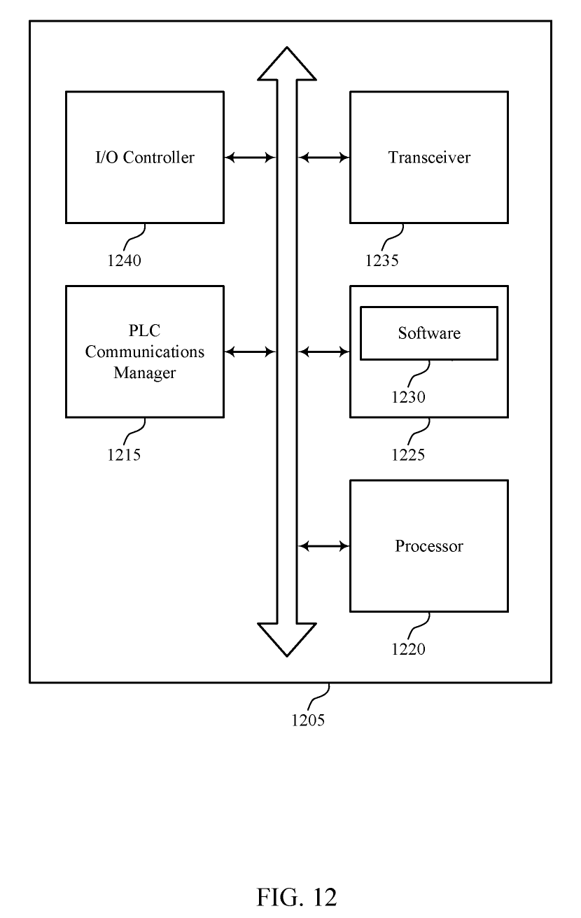

The receiver 910 may receive information such as packets, user data, or control information associated with various information channels (such as control channels, data channels, and information related to PLC interference mitigation for DSL networks, etc.). Information may be passed on to other components of the device 905. The receiver 910 may be an example of aspects of the transceiver 1235 described with reference to FIG. 12. The receiver 910 may utilize a single antenna or a set of antennas.

The PLC communications manager 915 may be an example of aspects of the PLC communications manager 1215 described with reference to FIG. 12.

The PLC communications manager 915 may perform communications with a second PLC device. The PLC communications manager 915 may refrain from entering a measurement mode prior to receiving a mitigation parameter. In some implementations, the PLC communications manager 915 may receive, at the first PLC device, the mitigation parameter based on the performed communications, and apply, at the first PLC device, the mitigation parameter for subsequent communications with the second PLC device.

The transmitter 920 may transmit signals generated by other components of the device. In some implementations, the transmitter 920 may be collocated with the receiver 910 in a transceiver module. For example, the transmitter 920 may be an example of aspects of the transceiver 1235 described with reference to FIG. 12. The transmitter 920 may utilize a single antenna or a set of antennas.

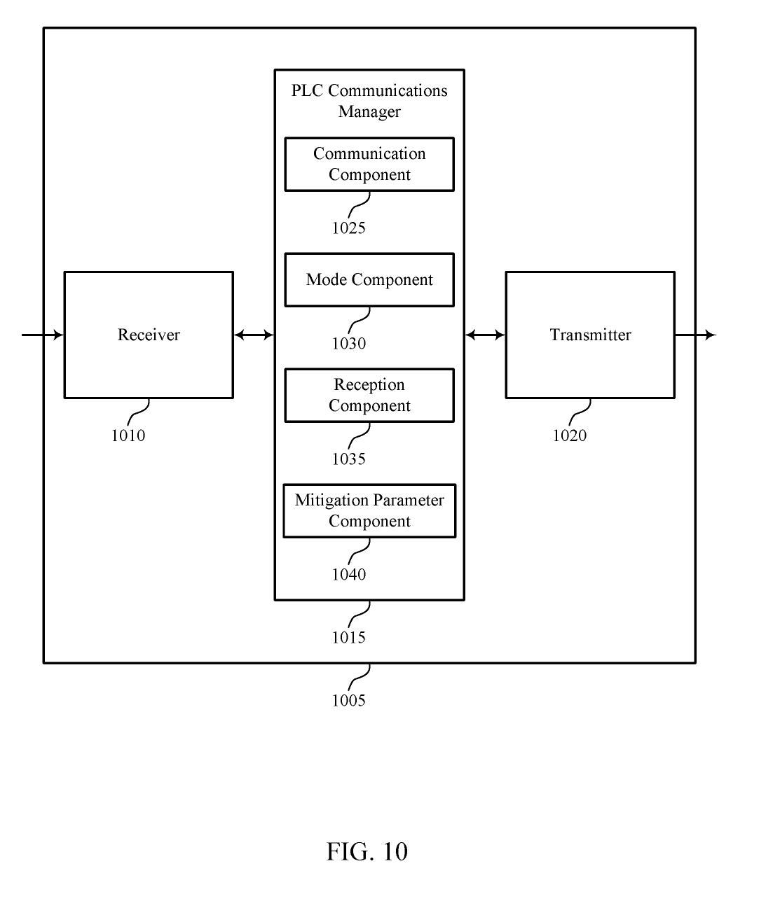

FIG. 10 shows an example device 1005 that supports PLC interference mitigation for DSL networks. The device 1005 may be an example of aspects of a device 905 as described with reference to FIG. 9 or a PLC device as described herein. The device 1005 may include a receiver 1010, a PLC communications manager 1015, and a transmitter 1020. The device 1005 also may include a processor. Each of these components may be in communication with one another (such as via one or more buses).

The receiver 1010 may receive information such as packets, user data, or control information associated with various information channels (such as control channels, data channels, and information related to PLC interference mitigation for DSL networks, etc.). Information may be passed on to other components of the device 1005. The receiver 1010 may be an example of aspects of the transceiver 1235 described with reference to FIG. 12. The receiver 1010 may utilize a single antenna or a set of antennas.

The PLC communications manager 1015 may be an example of aspects of the PLC communications manager 1215 described with reference to FIG. 12. The PLC communications manager 1015 also may include a communication component 1025, a mode component 1030, a reception component 1035, and a mitigation parameter component 1040.

The communication component 1025 may perform communications with a second PLC device and also may perform subsequent communications with the second PLC device based on the applied mitigation parameter.

The mode component 1030 may refrain from entering a measurement mode prior to receiving a mitigation parameter. In some implementations, refraining from entering the measurement mode prior to receiving the mitigation parameter includes: refraining from transmitting a measurement mode packet.

The reception component 1035 may receive, at the first PLC device, the mitigation parameter based on the performed communications. In some implementations, the mitigation parameter includes a power configuration common to each of the first PLC device and the second PLC device.

The mitigation parameter component 1040 may apply, at the first PLC device, the mitigation parameter for subsequent communications with the second PLC device.

The transmitter 1020 may transmit signals generated by other components of the device. In some implementations, the transmitter 1020 may be collocated with a receiver 1010 in a transceiver module. For example, the transmitter 1020 may be an example of aspects of the transceiver 1235 described with reference to FIG. 12. The transmitter 1020 may utilize a single antenna or a set of antennas.

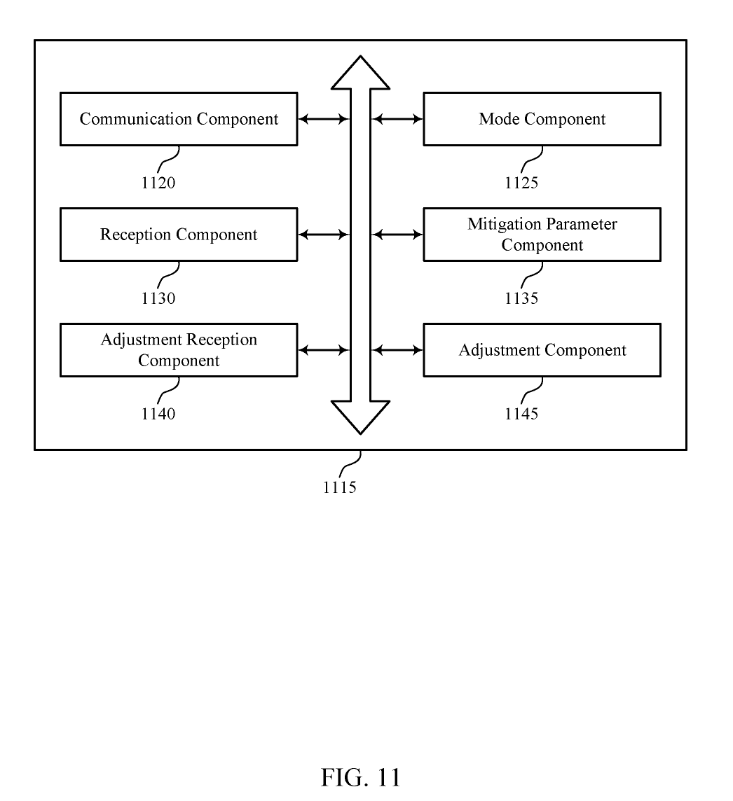

FIG. 11 shows an example PLC communications manager 1115 supporting PLC interference mitigation for DSL networks. The PLC communications manager 1115 may be an example of aspects of a PLC communications manager described with reference to FIGS. 9, 10, and 12. The PLC communications manager 1115 may include a communication component 1120, a mode component 1125, a reception component 1130, a mitigation parameter component 1135, an adjustment reception component 1140, and an adjustment component 1145. Each of these modules may communicate, directly or indirectly, with one another (such as via one or more buses).

The communication component 1120 may perform communications with a second PLC device and also may perform subsequent communications with the second PLC device based on the applied mitigation parameter. The mode component 1125 may refrain from entering a measurement mode prior to receiving a mitigation parameter. In some implementations, refraining from entering the measurement mode prior to receiving the mitigation parameter includes: refraining from transmitting a measurement mode packet. The reception component 1130 may receive, at the first PLC device, the mitigation parameter based on the performed communications. In some implementations, the mitigation parameter includes a power configuration common to each of the first PLC device and the second PLC device. The mitigation parameter component 1135 may apply, at the first PLC device, the mitigation parameter for subsequent communications with the second PLC device. The adjustment reception component 1140 may receive an adjusted mitigation parameter based on the subsequent communications. The adjustment component 1145 may apply the adjusted mitigation parameter for additional communications with the second PLC device.

FIG. 12 shows an example device that supports PLC interference mitigation for DSL networks. The device 1205 may be an example of or include the components of a PLC device as described herein. The device 1205 may include components for bi-directional voice and data communications including components for transmitting and receiving communications, including a PLC communications manager 1215, a processor 1220, a memory 1225, software 1230, a transceiver 1235, and an I/O controller 1240. These components may be in electronic communication via one or more buses (such as bus 1210).

The processor 1220 may be configured to execute computer-readable instructions stored in the memory 1225 to implement aspects of the present disclosure, including code to support PLC interference mitigation for DSL networks.

Transceiver 1235 may communicate bi-directionally, via one or more antennas, wired, or wireless links as described above. For example, the transceiver 1235 may represent a wireline transceiver and may communicate bi-directionally with another wireline transceiver. The transceiver 1235 also may include a modem to modulate the packets and provide the modulated packets to the wireline for transmission, and to demodulate packets received from the wireline.

The I/O controller 1240 may manage input and output signals for the device 1205. The I/O controller 1240 also may manage peripherals not integrated into the device 1205. In some implementations, the I/O controller 1240 may represent a physical connection or port to an external peripheral. In some implementations, the I/O controller 1240 may utilize an operating system such as iOS®, ANDROID®, MS-DOS®, MS-WINDOWS®, macOS®, UNIX®, LINUX®, or another known operating system. In some other implementations, the I/O controller 1240 may represent or interact with a modem, a keyboard, a mouse, a touchscreen, or a similar device. In some implementations, the I/O controller 1240 may be implemented as part of a processor (such as processor 1220). In some implementations, a user may interact with the device 1205 via the I/O controller 1240 or via hardware components controlled by the I/O controller 1240.

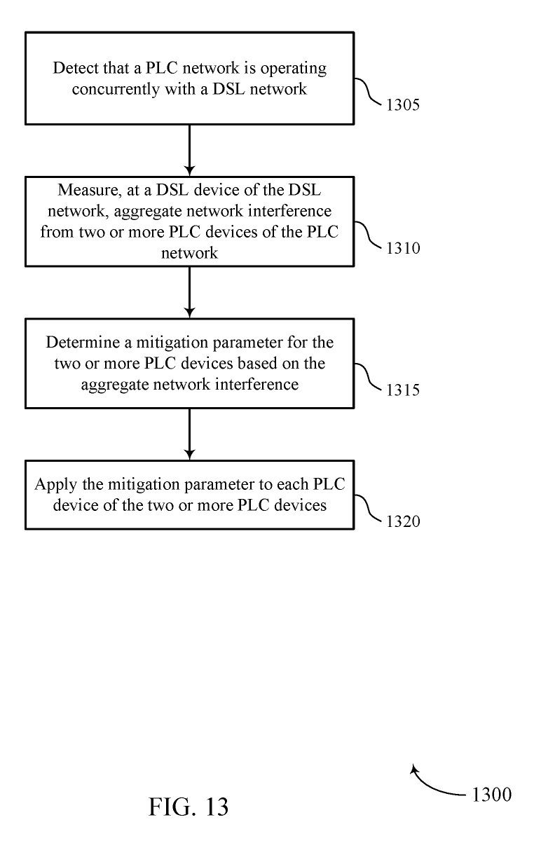

FIG. 13 shows an example method 1300 for PLC interference mitigation for DSL networks. The operations of method 1300 may be implemented by a CPE 210, an arbiter 230, or their components as described herein. For example, the operations of method 1300 may be performed by a communications manager as described with reference to FIGS. 5-8. In some implementations, a CPE 210 or an arbiter 230 may execute a set of codes to control the functional elements of the device to perform the functions described below. Additionally, or alternatively, the CPE 210 or the arbiter 230 may perform aspects of the functions described below using special-purpose hardware.

At block 1305, the CPE 210 or the arbiter 230 may detect that a PLC network is operating concurrently with a DSL network. The operations of block 1305 may be performed according to the methods described herein. In some implementations, aspects of the operations of block 1305 may be performed by a network detector as described with reference to FIGS. 5-8.

At block 1310, the CPE 210 or the arbiter 230 may measure, at a DSL device of the DSL network, aggregate network interference from two or more PLC devices of the PLC network. The operations of block 1310 may be performed according to the methods described herein. In some implementations, aspects of the operations of block 1310 may be performed by a measurement component as described with reference to FIGS. 5-8.

At block 1315, the CPE 210 or the arbiter 230 may determine a mitigation parameter for the two or more PLC devices based at least in part on the aggregate network interference. The operations of block 1315 may be performed according to the methods described herein. In some implementations, aspects of the operations of block 1315 may be performed by a parameter component as described with reference to FIGS. 5-8.

At block 1320, the CPE 210 or the arbiter 230 may apply the mitigation parameter to each PLC device of the two or more PLC devices. The operations of block 1320 may be performed according to the methods described herein. In some implementations, aspects of the operations of block 1320 may be performed by a mitigation component as described with reference to FIGS. 5-8.

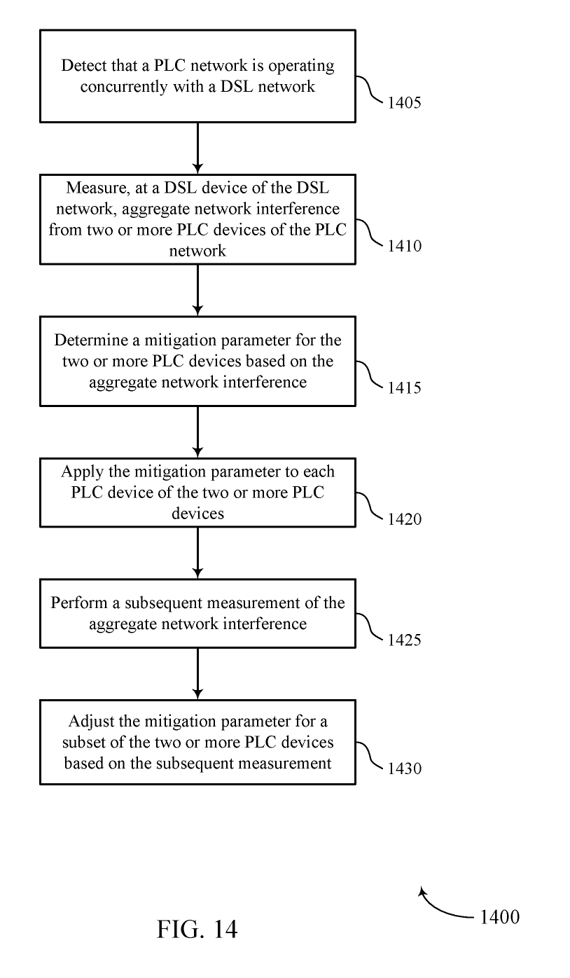

FIG. 14 shows an example method 1400 for PLC interference mitigation for DSL networks. The operations of method 1400 may be implemented by a CPE 210, an arbiter 230, or their components as described herein. For example, the operations of method 1400 may be performed by a communications manager as described with reference to FIGS. 5-8. In some implementations, a CPE 210 or an arbiter 230 may execute a set of codes to control the functional elements of the device to perform the functions described below. Additionally, or alternatively, the CPE 210 or the arbiter 230 may perform aspects of the functions described below using special-purpose hardware.

At block 1405, the CPE 210 or the arbiter 230 may detect that a PLC network is operating concurrently with a DSL network. The operations of block 1405 may be performed according to the methods described herein. In some implementations, aspects of the operations of block 1405 may be performed by a network detector as described with reference to FIGS. 5-8.

At block 1410, the CPE 210 or the arbiter 230 may measure, at a DSL device of the DSL network, aggregate network interference from two or more PLC devices of the PLC network. The operations of block 1410 may be performed according to the methods described herein. In some implementations, aspects of the operations of block 1410 may be performed by a measurement component as described with reference to FIGS. 5-8.

At block 1415, the CPE 210 or the arbiter 230 may determine a mitigation parameter for the two or more PLC devices based at least in part on the aggregate network interference. The operations of block 1415 may be performed according to the methods described herein. In some implementations, aspects of the operations of block 1415 may be performed by a parameter component as described with reference to FIGS. 5-8.

At block 1420, the CPE 210 or the arbiter 230 may apply the mitigation parameter to each PLC device of the two or more PLC devices. The operations of block 1420 may be performed according to the methods described herein. In some implementations, aspects of the operations of block 1420 may be performed by a mitigation component as described with reference to FIGS. 5-8.

At block 1425, the CPE 210 or the arbiter 230 may perform a subsequent measurement of the aggregate network interference. The operations of block 1425 may be performed according to the methods described herein. In some implementations, aspects of the operations of block 1425 may be performed by a measurement component as described with reference to FIGS. 5-8.

At block 1430, the CPE 210 or the arbiter 230 may adjust the mitigation parameter for a subset of the two or more PLC devices based at least in part on the subsequent measurement. The operations of block 1430 may be performed according to the methods described herein. In some implementations, aspects of the operations of block 1430 may be performed by a mitigation component as described with reference to FIGS. 5-8.

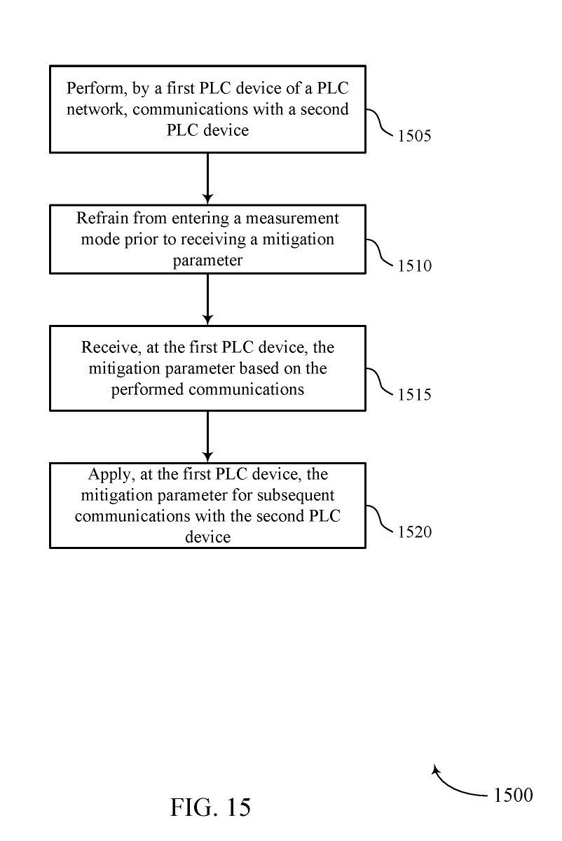

FIG. 15 shows an example method 1500 for PLC interference mitigation for DSL networks. The operations of method 1500 may be implemented by a PLC device or its components as described herein. For example, the operations of method 1500 may be performed by a PLC communications manager as described with reference to FIGS. 9-12. In some implementations, a PLC device may execute a set of codes to control the functional elements of the device to perform the functions described below. Additionally, or alternatively, the PLC device may perform aspects of the functions described below using special-purpose hardware.

At block 1505, a first PLC device of a PLC network may perform communications with a second PLC device. The operations of block 1505 may be performed according to the methods described herein. In some implementations, aspects of the operations of block 1505 may be performed by a communication component as described with reference to FIGS. 9-12.

At block 1510, the first PLC device may refrain from entering a measurement mode prior to receiving a mitigation parameter. The operations of block 1510 may be performed according to the methods described herein. In some implementations, aspects of the operations of block 1510 may be performed by a mode component as described with reference to FIGS. 9-12.

At block 1515, the first PLC device may receive the mitigation parameter based at least in part on the performed communications. The operations of block 1515 may be performed according to the methods described herein. In some implementations, aspects of the operations of block 1515 may be performed by a reception component as described with reference to FIGS. 9-12.

At block 1520, the first PLC device may apply the mitigation parameter for subsequent communications with the second PLC device. The operations of block 1520 may be performed according to the methods described herein. In some implementations, aspects of the operations of block 1520 may be performed by a mitigation parameter component as described with reference to FIGS. 9-12.

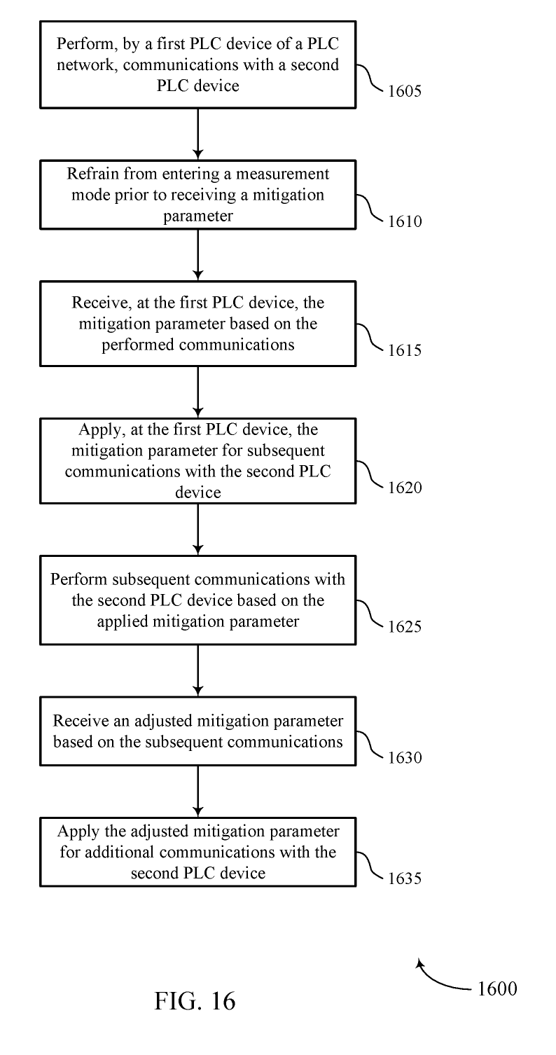

FIG. 16 shows an example method 1600 for PLC interference mitigation for DSL networks. The operations of method 1600 may be implemented by a PLC device or its components as described herein. For example, the operations of method 1600 may be performed by a PLC communications manager as described with reference to FIGS. 9-12. In some implementations, a PLC device may execute a set of codes to control the functional elements of the device to perform the functions described below. Additionally, or alternatively, the PLC device may perform aspects of the functions described below using special-purpose hardware.

At block 1605, a first PLC device of a PLC network may perform communications with a second PLC device. The operations of block 1605 may be performed according to the methods described herein. In some implementations, aspects of the operations of block 1605 may be performed by a communication component as described with reference to FIGS. 9-12.

At block 1610, the first PLC device may refrain from entering a measurement mode prior to receiving a mitigation parameter. The operations of block 1610 may be performed according to the methods described herein. In some implementations, aspects of the operations of block 1610 may be performed by a mode component as described with reference to FIGS. 9-12.

At block 1615, the first PLC device may receive the mitigation parameter based at least in part on the performed communications. The operations of block 1615 may be performed according to the methods described herein. In some implementations, aspects of the operations of block 1615 may be performed by a reception component as described with reference to FIGS. 9-12.

At block 1620, the first PLC device may apply, at the first PLC device, the mitigation parameter for subsequent communications with the second PLC device. The operations of block 1620 may be performed according to the methods described herein. In some implementations, aspects of the operations of block 1620 may be performed by a mitigation parameter component as described with reference to FIGS. 9-12.

At block 1625, the first PLC device may perform subsequent communications with the second PLC device based at least in part on the applied mitigation parameter. The operations of block 1625 may be performed according to the methods described herein. In some implementations, aspects of the operations of block 1625 may be performed by a communication component as described with reference to FIGS. 9-12.

At block 1630, the first PLC device may receive an adjusted mitigation parameter based at least in part on the subsequent communications. The operations of block 1630 may be performed according to the methods described herein. In some implementations, aspects of the operations of block 1630 may be performed by an adjustment reception component as described with reference to FIGS. 9-12.

At block 1635, the first PLC device may apply the adjusted mitigation parameter for additional communications with the second PLC device. The operations of block 1635 may be performed according to the methods described herein. In some implementations, aspects of the operations of block 1635 may be performed by an adjustment component as described with reference to FIGS. 9-12.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an ASIC, a FPGA or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus for wireline communications, comprising:
a processor;
a memory in electronic communication with the processor; and
instructions stored in the memory and operable, when executed by the processor, to cause the apparatus to:
detect that a power line communications (PLC) network is operating concurrently with a digital subscriber line (DSL) network;
measure, at a DSL device of the DSL network, aggregate network interference from two or more PLC devices of the PLC network;
determine a mitigation parameter for the two or more PLC devices based at least in part on the aggregate network interference; and
apply the mitigation parameter to each PLC device of the two or more PLC devices.

2. The apparatus of claim 1, wherein the instructions are further executable by the processor to:
perform a subsequent measurement of the aggregate network interference; and
adjust the mitigation parameter for a subset of the two or more PLC devices based at least in part on the subsequent measurement.

3. The apparatus of claim 2, wherein the instructions are further executable by the processor to:
increase a power configuration for the subset of the two or more PLC devices based at least in part on the aggregate network interference or the subsequent measurement of the aggregate network interference.

4. The apparatus of claim 1, wherein:
the aggregate network interference is measured while each PLC device of the two or more PLC devices are actively communicating.

5. The apparatus of claim 1, wherein:
the mitigation parameter is determined and applied by an arbitration function, wherein the DSL device comprises the arbitration function.

6. The apparatus of claim 1, wherein the instructions are further executable by the processor to:
determine interference associated with an individual PLC device of the two or more PLC devices based at least in part on the aggregate network interference; and
determine an individual mitigation parameter for the individual PLC device based at least in part on the interference associated with the individual PLC device.

7. The apparatus of claim 1, wherein the instructions executable by the processor to detect that the PLC network is operating concurrently with the DSL network further comprise instructions executable by the processor to:
identify, by the DSL device, the two or more PLC devices of the PLC network.

8. A method for wireline communications, comprising:
detecting that a power line communications (PLC) network is operating concurrently with a digital subscriber line (DSL) network;
measuring, at a DSL device of the DSL network, aggregate network interference from two or more PLC devices of the PLC network;
determining a mitigation parameter for the two or more PLC devices based at least in part on the aggregate network interference; and
applying the mitigation parameter to each PLC device of the two or more PLC devices.

9. The method of claim 8, further comprising:
performing a subsequent measurement of the aggregate network interference; and
adjusting the mitigation parameter for a subset of the two or more PLC devices based at least in part on the subsequent measurement.

10. The method of claim 9, further comprising:
increasing a power configuration for the subset of the two or more PLC devices based at least in part on the aggregate network interference or the subsequent measurement of the aggregate network interference.

11. The method of claim 8, wherein applying the mitigation parameter comprises:
transmitting the mitigation parameter to each PLC device of the two or more PLC devices.

12. The method of claim 8, wherein:
the aggregate network interference is measured while each PLC device of the two or more PLC devices are actively communicating.

13. The method of claim 8, wherein:
the mitigation parameter is determined and applied by an arbitration function, wherein the DSL device comprises the arbitration function.

14. The method of claim 8, further comprising:
determining interference associated with an individual PLC device of the two or more PLC devices based at least in part on the aggregate network interference; and
determine an individual mitigation parameter for the individual PLC device based at least in part on the interference associated with the individual PLC device.

15. The method of claim 8, wherein measuring the aggregate network interference comprises:
measuring signals from multiple PLC devices of the two or more PLC devices.

16. The method of claim 8, wherein detecting that the PLC network is operating concurrently with the DSL network comprises:
identifying, by the DSL device, the two or more PLC devices of the PLC network.

17. An apparatus for wireline communications, comprising:
means for detecting that a power line communications (PLC) network is operating concurrently with a digital subscriber line (DSL) network;
means for measuring, at a DSL device of the DSL network, aggregate network interference from two or more PLC devices of the PLC network;
means for determining a mitigation parameter for the two or more PLC devices based at least in part on the aggregate network interference; and
means for applying the mitigation parameter to each PLC device of the two or more PLC devices.

18. The apparatus of claim 17, further comprising:
means for performing a subsequent measurement of the aggregate network interference; and
means for adjusting the mitigation parameter for a subset of the two or more PLC devices based at least in part on the subsequent measurement.

19. The apparatus of claim 18, further comprising:
means for increasing a power configuration for the subset of the two or more PLC devices based at least in part on the aggregate network interference or the subsequent measurement of the aggregate network interference.

20. The apparatus of claim 17, wherein the means for applying the mitigation parameter comprises:
means for transmitting the mitigation parameter to each PLC device of the two or more PLC devices.

21. The apparatus of claim 17, wherein:
the aggregate network interference is measured while each PLC device of the two or more PLC devices is communicating.

22. The apparatus of claim 17, wherein:
the mitigation parameter is determined and applied by an arbitration function, wherein the DSL device comprises the arbitration function.

23. The apparatus of claim 17, further comprising:
means for determining interference associated with an individual PLC device of the two or more PLC devices based at least in part on the aggregate network interference; and
means for determining an individual mitigation parameter for the individual PLC device based at least in part on the interference associated with the individual PLC device.

24. The apparatus of claim 17, wherein the means for measuring the aggregate network interference comprises:
means for measuring signals from multiple PLC devices of the two or more PLC devices.

25. The apparatus of claim 17, wherein the means for detecting that the PLC network is operating concurrently with the DSL network comprises:
means for identifying, by the DSL device, the two or more PLC devices of the PLC network.

26. A method for wireline communications, comprising:
performing, by a first power line communications (PLC) device of a PLC network, communications with a second PLC device;
refraining from entering a measurement mode prior to receiving a mitigation parameter;
receiving, at the first PLC device, the mitigation parameter based at least in part on the performed communications; and
applying, at the first PLC device, the mitigation parameter for subsequent communications with the second PLC device.

27. The method of claim 26, further comprising:
performing subsequent communications with the second PLC device based at least in part on the applied mitigation parameter.

28. The method of claim 27, further comprising:
receiving an adjusted mitigation parameter based at least in part on the subsequent communications; and
applying the adjusted mitigation parameter for additional communications with the second PLC device.

29. The method of claim 26, wherein refraining from entering the measurement mode prior to receiving the mitigation parameter comprises:
refraining from transmitting a measurement mode packet.

30. The method of claim 26, wherein:
the mitigation parameter comprises a power configuration common to each of the first PLC device and the second PLC device.
